(19) United States
(12) Patent Application Publication
(10) Pub. No.: US 2012/0217297 A1
(43) Pub. Date: Aug. 30, 2012

(54) SYSTEM AND METHOD FOR CHECK WRITING USING A PORTABLE DEVICE WITH NEAR FIELD COMMUNICATION SYSTEMS

(76) Inventor: Seung Pil Kim, San Francisco, CA (US)

(21) Appl. No.: 13/036,013

(22) Filed: Feb. 28, 2011

(51) Int. Cl. G06Q 90/00

(52) U.S. Cl. 235/380

(57) ABSTRACT

A system comprises a set of two devices communicating each other, using near field communication systems (NFC) where one of said devices is connected to a merchant's POS system via wireless network or a cable. The other device is a portable device belongs to a customer. The customer's portable device authorizes transactions and further writing a check. The merchant side device communicates with the customer's portable device and receives customer's check information. The check information is sent to the merchant's POS system where the check can be printed. The check can have a signature using one of the three options; 1) hand writing 2) electronically captured signature from a signature pad, and 3) electronic signature received from the customer's portable device. The customer's check image can be printed for conventional check processing or directly used for the check image based checking systems. The transaction data on either side can be exported to other programs for more sophisticated financial management if necessary.

### CROSS-REFERENCE TO RELATED APPLICATIONS

| U.S. Pat. No. 7,802,719 | Sep. 28, 2010, | Johnson, et al. | Current: |
|---|---|---|---|
| | | | 455/41.2, |
| U.S. Pat. No. 7,756,467 | Jul. 13, 2010, | Bent, et al. | 455/3.04 |
| U.S. Pat. No. 7,248,834 | Jul. 24, 2007, | Matsuo, et al. | 455/41.2 |

### BACKGROUND

1. The Field of the Invention

This invention relates to systems and methods for writing a check using a portable device and, more particularly, to novel systems and methods for improving the process of check writing in terms of convenience, speed and security.

2. The Background Art

Check writing has been the backbone of financial transactions in modern era. However, the major drawback of check based transactions has been the fact that it is a paper based system, and requires checkbook be readily available. It is particularly inconvenient in a busy environment such as grocery checkouts or restaurants. Therefore, it is highly desirable that one does not have to carry such checkbooks in anticipation of writing checks, and further reduce time required to write checks in a busy checkout line.

In recent years, paperless check system has been utilized where check writing has been replaced by check printing by a third party with an authorization from a check issuer, for example, by a verbal authorization over the phone. Such a system requires a prior set up between banks and merchants for such transactions, and not readily available for all the transactions. Recently, paperless check processing became common where electronic image of checks replaces the functions of paper checks once the original paper checks are deposited and scanned. Recently, even an original paper check needs not be deposited in the banks where an image capture of the original check can be used instead. These paperless check processing are based on the imbedded security of bank account based on password protection and secure electronic communication systems.

Due to recent advances in smart phones, it is possible to automate check writing in a secure and convenient way without carrying checkbooks and causing delays in checkout lines while writing checks. A customer's check can be printed out as easily as traditional receipt printouts with secure and fast communications between the customer's portable device and merchant's point-of-sales (POS) systems. This novel check writing scheme provides high security and convenience by combining conventional signature based checking and secure communication systems of portable devices such as smart phones.

### BRIEF SUMMARY AND OBJECTS OF THE INVENTION

In view of the foregoing, it is an objective of the present invention to provide an improved system and method for check writing in various environments, for example, busy store checkout lines or restaurants.

It is a further objective of the invention to provide a system and method for secure and convenient way for writing checks using a portable device such as smart phones.

In accordance with the present invention, the foregoing objects are met by the provision of devices equipped with near field communication system that allows fast and secure way of exchanging data between a customer's portable device and merchant's POS(point of Sales) system and an optional printing device attached to the POS that prints out checks with all the necessary information, possibly, except for the payer's signature.

According to certain aspect of the invention, the foregoing objects are met by an application software on the customer side portable device that provides necessary user interfaces and manages check writing processes, and another application software on the merchant side NFC enabled device connected to the POS system.

According to certain aspect of the invention, the application software on the customer side portable device recognizes merchant's near-field communication system and initiates check writing process upon approval from a user.

According to another aspects of the invention, the application software on the customer side portable device authorizes release of the information necessary to write a check such as name, address, bank account and check serial number, etc., by using a authorization code such as a password.

According to another aspect of the invention, the application software on the portable device receives merchant's information, such as business name, address as well as details of charges.

According to another aspect of the invention, the application software on the customer side portable device can allow adding a certain percentage of the total cost or a customer specified amount as gratitude as necessary.

According to another aspect of the invention, the merchant's NFC enabled device has displays that facilitate the process of check writing steps, such as message display and status lights.

According to a certain aspect of the invention, a transaction between a customer and a merchant is completed by signing a check where signing can be done by; 1) hand writing a signature on a printed check presented to a customer, 2)capturing a signature from a signature capture pad, 3) transmitting an electronic signature stored in the customer's portable device.

### BRIEF DESCRIPTION OF THE DRAWINGS

FIG. 1 is an illustration of an embodiment of an exemplary system set up according to the present invention.

FIG. 2-A is the first part of the flowchart showing the sequence of events for processing according to the present invention, where merchant's NFC enabled device is portable, implemented as a service tray in the current embodiment, and connected via wireless network.

FIG. 2-B is the first part of the flowchart showing the sequence of events for processing according to the present invention, where merchant's NFC enabled device is cable connected and attached to the main body of the POS system.

FIG. 2-C and FIG. 2-D are the rest of the flowchart.

FIG. 3-A shows a NFC enabled service tray where a bill is presented and customer is instructed to place a portable device.

FIG. 3-B shows a NFC enabled service tray communicating with a customer's portable device and waiting for customer's approval for check writing.

FIG. 3-C shows a NFC enabled service tray where customer is instructed to write a signature on a printed check.

FIG. 3-D shows another embodiment of service tray that is equipped with a signature capture device, a device well known to a person in the art, to capture a customer's signature.

FIG. 4-A shows a cable connected merchant side NFC enabled device according to the present invention where said POS display instructs a customer to place a portable device close to the embedded NFC sensor to initiate information exchange.

FIG. 4-B shows a cable connected merchant side NFC enabled device according to the present invention where said POS display instructs a customer to approve information exchange for check writing.

FIG. 4-C shows a cable connected merchant side NFC enabled device according to the present invention where said POS display instructs a customer to sign on the pad of an electronic signature capturing device.

FIG. 4-D shows a cable connected merchant side NFC enabled device according to the present invention where said POS display instructs a customer to sign a printed check.

### DETAILED DESCRIPTION OF EMBODIMENT

It is not intended that the invention be described here in its entirety. Rather, further features, aspects and advantages of the invention will be set forth in or apparent from the following description and drawings.

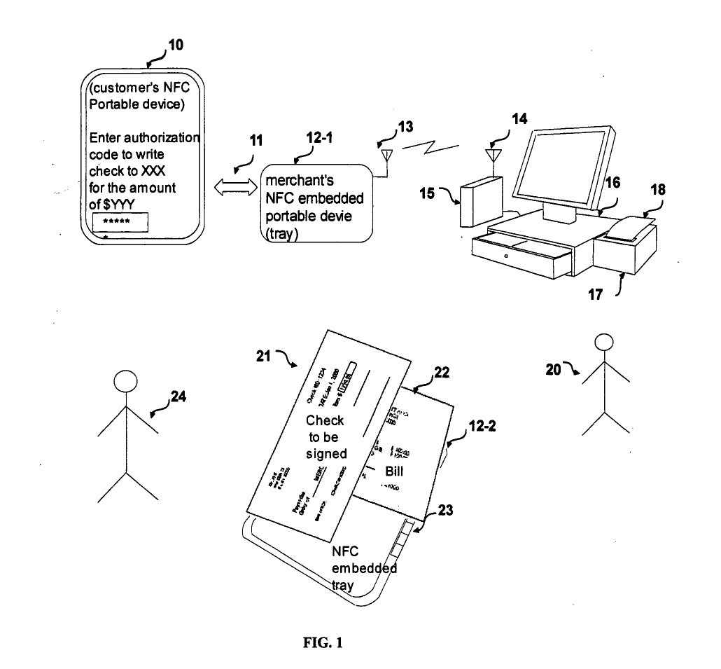

With reference to FIG. 1, an illustration of an exemplary system according to the present invention is shown. A NFC enabled customer's portable device 10 is communicating with a merchant's POS system 16 through a (merchant side) NFC enabled device 12-1. A printer 17, capable of printing checks, is connected to the POS system 16. The NFC enabled portable device 12-1 is connected to the main body of POS system via wireless network as noted by antenna 13 and 14 and a wireless network modem device 15. The NFC system requires that the distance between the two NFC devices, a customer devices 10 and merchant side device 12-1, as noted by the arrow 11, be around less than 5 inches, which provides a security based on the proximity requirement of the communication.

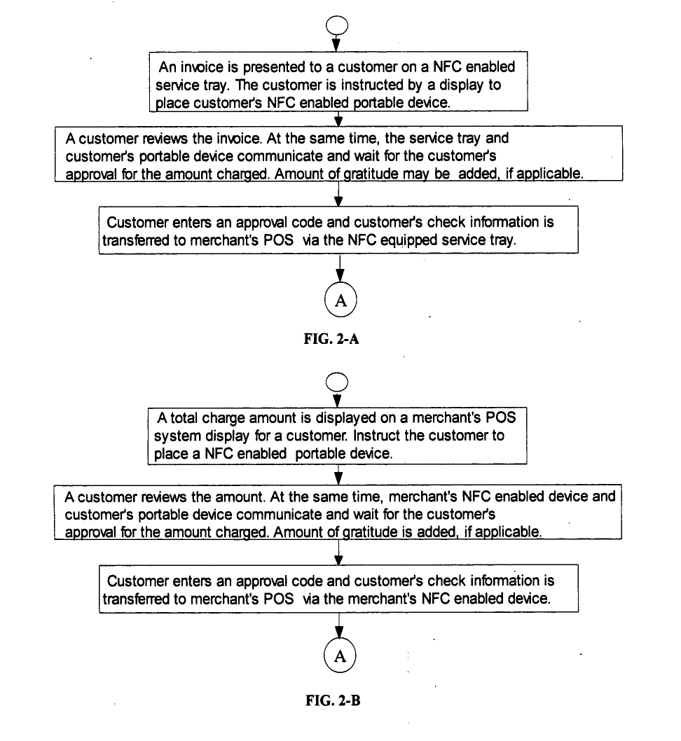

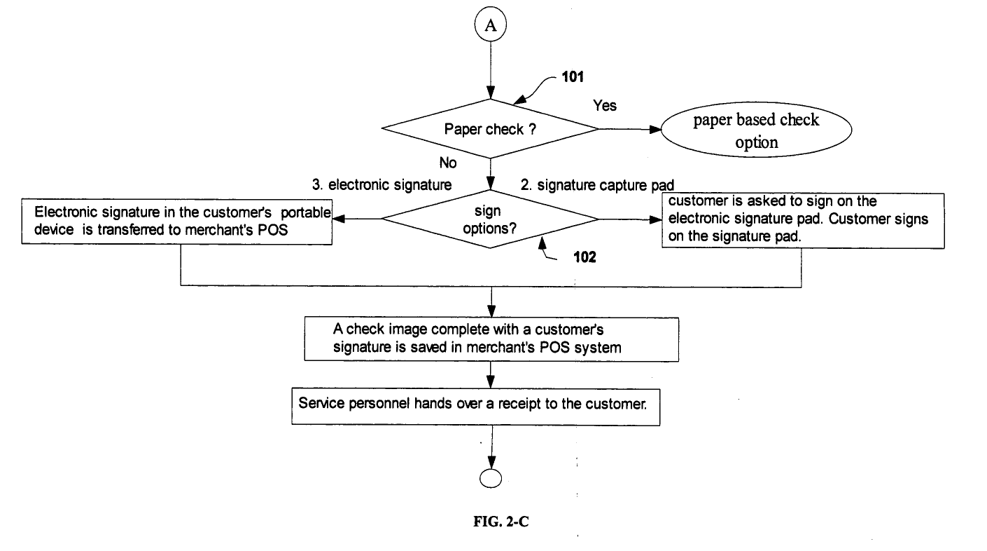

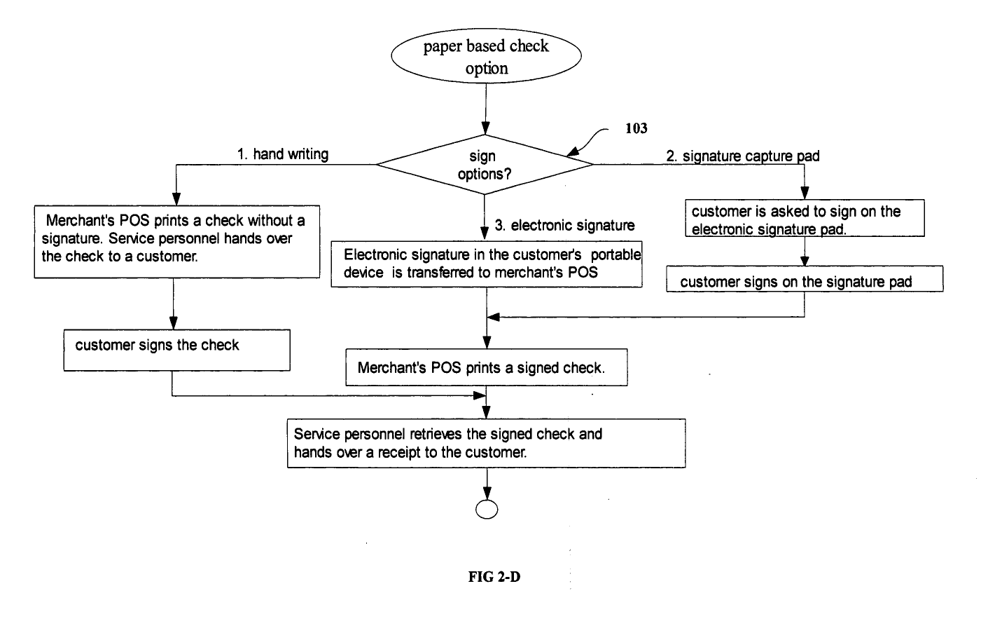

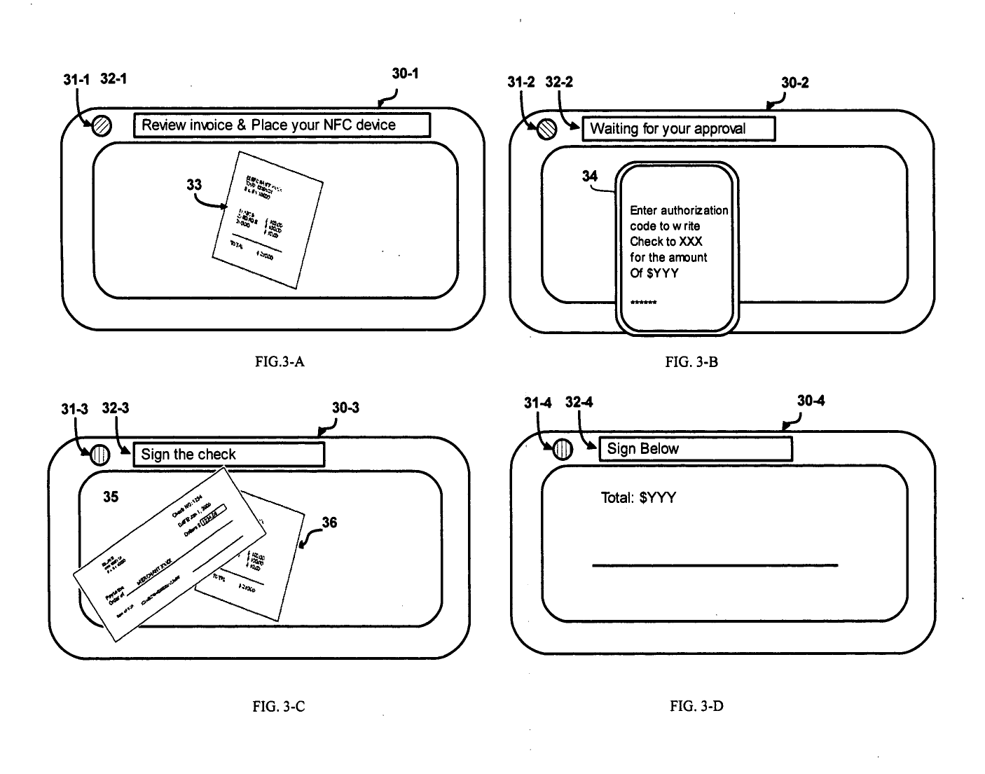

In an exemplary scenario shown in FIG. 1, a portable merchant side NFC enabled device 12-1, implemented as a service tray device as further sketched as 12-2, is presented to a customer 24 along with a bill. After the customer reviews the bill, s/he places a portable device 10 on the tray 12-1 (or 12-2), after being instructed by the display 23. The details of the display is shown as device 32-1 in FIG. 3-A. The service tray displays a message for the next step as shown in device 32-2, in FIG. 3-B. The status light devices 31-1, 31-2, 31-3, in FIG. 3-A, B,C, D, respectively, enable service personnel 20 in FIG. 1 recognizes the status of the check transaction without having to read the displays at a closer distance. When customer's portable device 34 (same as device 10 in FIG. 1) is placed on the merchant's NFC enabled device 30-2, device 34 and device 30-2 exchange information required for writing a check. When the information exchange is complete, the message display device 32-2 indicates that the customer needs to approve the check writing. The customer then looks at the display of the potable device 34 and approves the transaction by typing in a password or an approval code as sketched in FIG. 3-B. If a conventional paper based check processing option is chosen, the printer 17 in FIG. 1 prints the check with or without a signature based on the sign options explained below. The flowchart in FIG. 2-A˜FIG. 2-D depict processes depending on the options selected in the current invention. First, one decides whether a paper based check system or an image based check system is used. A paper check system has three sign options; 1) hand written signature, 2) signature captured from a signature pad, and 3) electronic signature received from customer's portable device. An image based check system has two options of 2) and 3) described before.

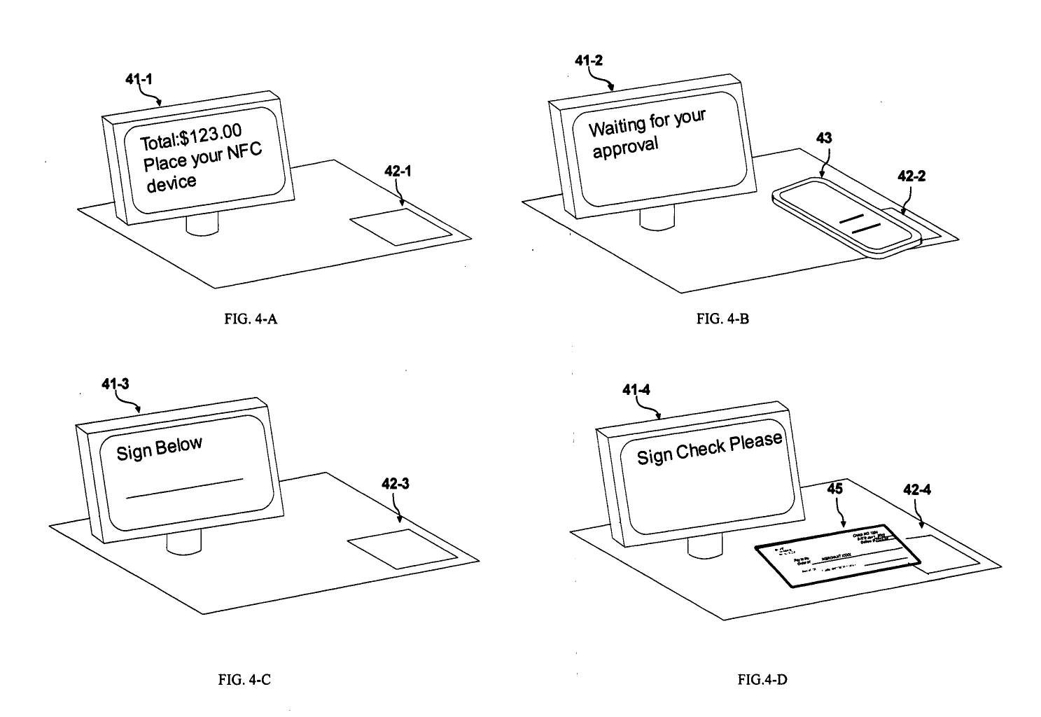

If the paper based check check system and hand writing option are chosen, the check 21 in FIG. 1 (redrawn as 35 in FIG. 3-C) is returned to the customer for a signature along with the receipt 22 in FIG. 1 (redrawn as 36 in FIG. 3-C). The customer is again instructed to sign the check by the message display 32-3 in FIG. 3-C. If signature capture pad option is enabled, the customer's signature is written directly on the pad of the signature capture device shown in FIG. 3-D and FIG. 4-C. If electronic signature option is selected, the electronic signature stored in a customer's portable device is transmitted to the POS system via the NFC systems. In the cases of 2) and 3) options, the check is printed including a signature without the need of customer's signing. These options, shown by decision blocks 101, 102 and 103 in FIG. 2-C and D, can be predetermined based on merchant's preference or made selectable by a customer. FIG. 2-C and -D show processes related to paper based check writing.

If an image based check option is chosen, only the sign options 2) and 3) described above are allowed. No printing is required of a check and allows fastest transactions amongst all different options. FIG. 2-C shows image based check writing process.

In another embodiment of the present invention, the merchant side NFC enabled device is not portable and wire connected to the POS system. Such an embodiment is suitable for grocery or retail check out environment, where customers are available close to the merchant's POS system throughout the process. The flowchart in FIG. 2-B depicts the processes, quite similar to FIG. 2-A except the fact that the user interface is through a POS system display. A customer is guided by the said display connected to the POS system as shown in FIG. 4-A˜FIG. 4-C, instead of a service tray displays previously shown in FIG. 3-A˜FIG. 3-D. First the customer is requested to place customer's portable device on the sensor (NFC antenna) as shown in FIG. 4-A. When the customer places the portable device as shown in FIG. 4-B, the necessary information is exchanged between the customer's portable device and the merchant's POS system through the NFC devices. Once the exchange is complete, the customer is requested to authorize the transaction as shown by the device 41-2 in FIG. 4-B. If an imaging based checking option is used, the customer's signature is sent through a sign option 2) or 3) described above. If the paper based checking option is used a customer can sign on the signature capture pad as shown by the device 41-3 in FIG. 4-C or on a printed check 45 as instructed by device 41-4 in FIG. 4-D, depending on the system set up.

What is claimed is:

1. A system for check writing comprised of;
a portable device (customer side) equipped with a NFC device, information storage device and a user interface, another (merchant side) device equipped with a NFC device with its own user interface, connected to a POS system through a wireless local area network or wired connections.

2. The device of claim 1, wherein said POS system is equipped with a printer capable of printing checks.

3. The device of claim 1, wherein said (customer side) portable device user interface securely authorizes transfer of check writing information to said POS system through said device (merchant side) with NFC.

4. The device of claim 1, wherein said (merchant side) device has status lights and/or a message display, indicating the status of the check writing process and guiding next steps.

5. The device of claim 1, wherein said (merchant side) device has an integrated signature capture system.

6. The device of claim 1, wherein said (customer side) portable device user interface allows to modify the total charge amount, for example, by adding gratitude, if necessary.

7. The device of claim 1, wherein the image of the check is generated with or without customer's signature.

8. The device of claim 1, wherein different sign options are implemented and selectable by a merchant or a customer

9. A method of check writing using a customer's portable device, wherein said customer's portable device is equipped with NFC device and exchanges information necessary for check writing with a merchant's NFC equipped device connected to a POS system with a printer.

10. The method of claim 9, wherein said (merchant side) NFC equipped device is connected to said POS system via wireless network, making said device portable, and necessary information exchange occurs at the customer service location without the customer's need for coming to said POS system.

11. The method of claim 9, wherein said information exchange is approved by a pass code.

12. The method of claim 9, wherein said information can be modified at customer's discretion, for example, for gratitude.

13. The method of claim 9, wherein a status light and/or display attached to said (merchant side) device help the process of check writing.

14. The method of claim 9, wherein a completed check, except for a signature, is printed from said printer and presented to a customer for a hand written signature.

15. The method of claim 9, wherein a completed check is printed from said printer using an electronic signature transferred from said customer's portable device.

16. The method of claim 9, wherein a completed check is printed from said printer using a signature captured by said POS system.

17. The method of claim 9, wherein an image of a completed check including a signature is generated and used for image based check processing.
